(19) United States
(12) Patent Application Publication
(10) Pub. No.: US 2023/0274091 A1
(43) Pub. Date: Aug. 31, 2023

(54) DIALOGUE SYSTEM WITH SLOT-FILLING STRATEGIES

(71) Applicant: Robert Bosch GmbH, Stuttgart (DE)

(72) Inventor: Xiaoyang GAO, San Jose, CA (US)

(21) Appl. No.: 17/681,264

(22) Filed: Feb. 25, 2022

(51) Int. Cl. G06F 40/35; H04L 51/02; G06F 16/332

(52) U.S. Cl. CPC G06F 40/35; H04L 51/02; G06F 16/3329

(57) ABSTRACT

Methods and systems of operating a dialogue system are provided. At a chatbot, a first input from a user is received and the first intent of the first input is identified. Based on the first intent, a slot-filling system is activated, wherein slot-filling context is stored in a conversation history in storage, wherein the slot-filling context corresponds to the first input. With the slot-filling system activated, the user is queried to provide a slot-filling answer. If a second intent of this answer is of a non-slot-filling manner, the user is queried to provide additional input associated with the second intent. Then, when a later third input is received, the third intent of the third input is determined based on the slot-filling context saved in history.

### TECHNICAL FIELD

The present disclosure relates to various slot-filling strategies for dialogue systems. In embodiments, a dialogue system is configured to provide information or service needed for a user by recognizing the user's intention through dialogue with the user. The dialogue system includes a slot-filling system to properly collect information for fulfilling user requests.

### BACKGROUND

A spoken dialogue system is a human-computer interaction system that tries to understand utterances or words spoken by a user and respond to the user effectively. Such dialogue systems have a wide range of applications, such as information searching (e.g., searching weather, flight schedules, train schedules, etc.) traveling, ticket reservation, food ordering, and the like. At-home assistants (e.g., AMAZON ECHO and APPLE HOMEPOD) integrate a dialogue system that receives spoken utterances from a user and, in turn, attempts to provide an accurate response. A chatbot is one example of a utilization of a dialogue system. A chatbot is an artificial intelligence (AI)-based application that can imitate a conversation with users in their natural language. A chatbot can react to user's requests and, in turn, deliver a particular service.

### SUMMARY

According to one embodiment, computer-implemented method of operating a dialogue system is provided. The method includes receiving a first input from a user at a chatbot, and identifying a first intent of the first input. The method includes, based on the first intent, activating a slot-filling system and saving slot-filling context in a stored conversation history, wherein the slot-filling context corresponds to the first input. With the slot-filling system activated, the following steps take place: at the chatbot, querying the user to provide a slot-filling answer; at the chatbot, receiving a second input from the user responsive to the querying; identifying a second intent of the second input, wherein the second intent is determined to have non-slot-filling intent; in response to the second intent of the second input having the non-slot-filling intent, querying the user to provide additional input associated with the second intent; at the chatbot, receiving a third input from the user; and determining that a third intent of the third input includes the slot-filling answer based on the slot-filling context saved in the conversation history.

In another embodiment, a system for operating a chatbot in a dialogue setting is provided. The system includes a human-machine interface (HMI) configured to receive input from a user and provide output to the user. The system includes one or more storage devices. The system includes one or more processors in communication with the HMI and the one or more storage devices. The one or more processors are programmed to: at the chatbot, receive a first input from the user; determine a first intent of the first input; store, in the one or more storage devices, slot-filling context associated with the determined first intent; at the chatbot, query the user to provide a slot-filling answer to fill a slot associated with the determined first intent; at the chatbot, receive a second input from the user responsive to the query; and determine a second intent of the second input based on the slot-filling context saved in storage.

In another embodiment, a computer-implemented method of operating a dialogue system includes: at a chatbot, receiving an input from a user; identifying a plurality of candidate intents corresponding to the input; generating a confidence score for each candidate intent, wherein the confidence score indicates a confidence that the corresponding candidate intent is a valid intent of the input; determining one or more of the candidate intents are part of a common intent group; merging the one or more candidate intents into a merged intent group having a confidence score represented by the aggregate of the confidence scores of the candidate intents within the merged intent group; selecting a largest of the confidence scores of the merged intent group or the plurality of candidate intents; and based on the largest of the confidence scores being the merged intent group, determining an intent of the input as being one of the candidate intents within the merged intent group.

### BRIEF DESCRIPTION OF THE DRAWINGS

FIG. 1 is a schematic diagram of an example of a dialogue system that includes a human-machine interface (HMI) and a dialogue computer, according to one embodiment.

FIG. 2 is a schematic diagram of an embodiment of the dialogue computer.

FIG. 3 is a schematic diagram of an embodiment of the dialogue system wherein the HMI is an electronic personal assistant.

FIG. 4 illustrates an example of a language model that may be used by the dialogue system, according to an embodiment.

FIG. 5 is a flowchart illustrating operation of a dialogue system according to an embodiment.

FIG. 6 is a flowchart illustrating operation of a dialogue system according to an embodiment.

FIG. 7 is an example of code used to define a slot-filling answer intent for the original intent without a required slot being provided, according to an embodiment.

FIGS. 8A-8B illustrate process flow diagrams illustrating intent grouping and conversation history to properly select an intent in different scenarios, wherein FIG. 8A illustrates a first process flow diagram in which an intent is selected when no slot-filling context in saved in the conversation history, and FIG. 8B illustrates a second process flow diagram in which a different intent is selected when a slot-filling context is saved in the conversation history.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

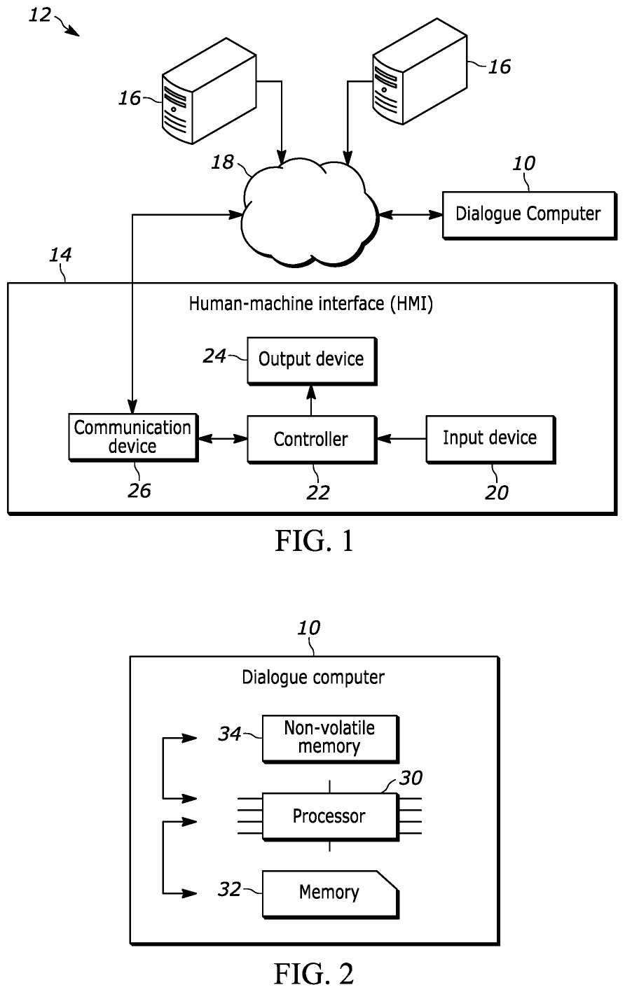

Turning now to the figures, wherein like reference numerals indicate like or similar features and/or functions, a dialogue computer 10 is shown for generating an answer to a query or question posed by a user (not shown). According to an example, FIG. 1 illustrates a question and answer (Q&A) system, also referred to as a chatbot system or dialogue system 12 that comprises a human-machine interface (HMI) 14 for the user, one or more storage media devices 16 (two are shown by way of example only), the dialogue computer 10, and a communication network 18 that may facilitate data communication between the HMI 14, the storage media devices 16, and the dialogue computer 10. As will be explained in detail below, the user may provide his/her query via text, speech, or the like using HMI 14, and the query may be transmitted to dialogue computer 10 (e.g., via communication network 18). Upon receipt, the dialogue computer 10 may utilize the dialogue system 12 disclosed herein. Using the dialogue system 12 disclosed herein improves question and answer accuracy, and provides more natural responses from the dialogue computer 10. The dialogue computer 10 described herein improves the user experience; for example, by providing more accurate responses to user queries and recalling information from the conversation history, users are less likely to become frustrated with a system that provides a computer-generated response.

A user of the dialogue system 12 may be a human being which communicates a query (i.e., a question) with a desire to receive a corresponding response. According to one embodiment, the query may regard any suitable subject matter. In other embodiments, the query may pertain to a predefined category of information (e.g., customer technical support for a product or service, ordering food, etc.). These are merely examples; other embodiments also exist and are contemplated herein. An example process of providing an answer to the user's query will be described following a description of illustrative elements of dialogue system 12.

Human-machine interface (HMI) 14 may comprise any suitable electronic input-output device which is capable of: receiving a query from a user, communicating with dialogue computer 10 in response to the query, receiving an answer from dialogue computer 10, and in response, providing the answer to the user. According to the illustrated example of FIG. 1, the HMI 14 may comprise an input device 20, a controller 22, an output device 24, and a communication device 26. The HMI 14 may be, for example, an electronic personal assistant (e.g., an ECHO by AMAZON, HOMEPOD by APPLE, etc.) or a digital personal assistant (e.g., ALEXA by AMAZON, CORTANA by MICROSOFT, SIRI by APPLE, etc.) on a mobile device. In other embodiments, the HMI 14 may be an internet web browser configured to communicate information back and forth between the user and the service provider. For example, the HMI 14 may be embodied on a website for a general store, restaurant, hardware store, etc.

The input device 20 may comprise one or more electronic input components for receiving a query from the user. Non-limiting examples of input components include: a microphone, a keyboard, a camera or sensor, an electronic touch screen, switches, knobs, or other hand-operated controls, and the like. Thus, via the input device 20, the HMI 14 may receive the query from user via any suitable communication format—e.g., in the form of typed text, uttered speech, user-selected symbols, image data (e.g., camera or video data), sign-language, a combination thereof, or the like. Further, the query may be received in any suitable language. As used herein, the term utterance is intended to mean spoken speech as well as written (e.g., typed) speech of a user.

The controller 22 may be any electronic control circuit configured to interact with and/or control the input device 20, the output device 24, and/or the communication device 26. Controller 22 may comprise a microprocessor, a field-programmable gate array (FPGA), or the like; however, in some examples only discrete circuit elements are used. According to an example, the controller 22 may utilize any suitable software as well (e.g., non-limiting examples include: DialogFlow™, a Microsoft chatbot framework, and Cognigy™). While not shown here, in some implementations, the dialogue computer 10 may communicate directly with the controller 22. Further, in at least one example, the controller 22 may be programmed with software instructions that comprise—in response to receiving at least some image data—determining user gestures and reading the user's lips. The controller 22 may provide the query to the dialogue computer 10 via the communication device 26. In some instances, the controller 22 may extract portions of the query and provide these portions to the dialogue computer 10—e.g., controller 22 may extract a subject of the sentence, a predicate of the sentence, an action of the sentence, a direct object of the sentence, etc.

The output device 24 may comprise one or more electronic output components for presenting an answer to the user, wherein the answer corresponds with a query received via the input device 20. Non-limiting examples of output components include: a loudspeaker, an electronic display (e.g., screen, touchscreen), or the like. In this manner, when the dialogue computer 10 provides an answer to the query, the HMI 14 may use the output device 24 to present the answer to the user according to any suitable format. Non-limiting examples include presenting the user with the answer in the form of audible speech, displayed text, one or more symbol images, a sign language video clip, or a combination thereof.

The communication device 26 may comprise any electronic hardware necessary to facilitate communication between dialogue computer 10 and at least one of controller 22, input device 20, or output device 24. Non-limiting examples of the communication device 26 include: a router, a modem, a cellular chipset, a satellite chipset, a short-range wireless chipset (e.g., facilitating Wi-Fi, Bluetooth, dedicated short-range communication (DSRC) or the like), or a combination thereof. In at least one example, the communication device 26 is optional. For example, the dialogue computer 10 could communicate directly with the controller 22, the input device 20, and/or the output device 24.

The storage media devices 16 may be any suitable writable and/or non-writable storage media communicatively coupled to the dialogue computer 10. While two are shown in FIG. 1, more or fewer may be used in other embodiments. According to at least one example, the hardware of each storage media device 16 may be similar or identical to one another; however, this is not required. According to an example, storage media device(s) 16 may be (or form part of) a database, a computer server, a push or pull notification server, or the like. In at least one example, storage media device(s) 16 comprise non-volatile memory; however, in other examples, they may comprise volatile memory instead of or in combination with non-volatile memory. Storage media device(s) 16 (or other computer hardware associated with devices 16) may be configured to provide data to dialogue computer 10 (e.g., via communication network 18). Also, as will be described herein, the storage media device(s) 16 may be configured to store conversation history for recall during a chat session. For example, if a slot-filling system is activated, the conversation history between the human and the dialogue computer 10 may be stored in the media device(s) 16, whereupon the dialogue computer 10 can recall part of the conversation history to see if a slot-filling answer was provided by the user based on context of the conversation. The data provided by storage media device(s) 16 may enable the operation of chatbots using structured data, unstructured data, or a combination thereof; however, in at least one embodiment, each storage media device 16 stores and/or communicates some type of unstructured data to dialogue computer 10.

Structured data may be data that is labeled and/or organized by field within an electronic record or electronic file. The structured data may include one or more knowledge graphs (e.g., having a plurality of nodes (each node defining a different subject matter domain), wherein some of the nodes are interconnected by at least one relation), a data array (an array of elements in a specific order), metadata (e.g., having a resource name, a resource description, a unique identifier, an author, and the like), a linked list (a linear collection of nodes of any type, wherein the nodes have a value and also may point to another node in the list), a tuple (an aggregate data structure), and an object (a structure that has fields and methods which operate on the data within the fields). In short, the structured data may be broken into classifications, where each classification of data may be assigned to a particular chatbot. For example, as will be described further herein, a “food” chatbot may include data enabling the system to respond to a user's query with information about food, while a “drinks” chatbot may include data enabling the system to respond to the user's query with information about drinks. Each master chatbot and assistant chatbot disclosed herein may be in structured data stored in storage media device 16, or in the dialogue computer 10 in memory 32 and/or 34 and accessed and processed by processor 30.

The structured data may include one or more knowledge types. Non-limiting examples include: a declarative commonsense knowledge type (scope comprising factual knowledge; e.g., “the sky is blue,” “Paris is in France,” etc.); a taxonomic knowledge type (scope comprising classification; e.g., football players are athletes,” “cats are mammals,” etc.); a relational knowledge type (e.g., scope comprising relationships; e.g., “the nose is part of the head,” “handwriting requires a hand and a writing instrument,” etc.); a procedural knowledge type (scope comprising prescriptive knowledge, a.k.a., order of operations; e.g., “one needs an oven before baking cakes,” “the electricity should be disconnected while the switch is being repaired,” etc.); a sentiment knowledge type (scope comprising human sentiments; e.g., “rushing to the hospital makes people worried,” “being on vacation makes people relaxed,” etc.); and a metaphorical knowledge type (scope comprising idiomatic structures; e.g., “time flies,” “it's raining cats and dogs,” etc.).

Unstructured data may be information that is not organized in a pre-defined manner (i.e., which is not structured data). Non-limiting examples of unstructured data include text data, electronic mail (e-mail) data, social media data, internet forum data, image data, mobile device data, communication data, and media data, just to name a few. Text data may comprise word processing files, spreadsheet files, presentation files, message field information of e-mail files, data logs, etc. Electronic mail (e-mail) data may comprise any unstructured data of e-mail (e.g., a body of an e-mail message). Social media data may comprise information from commercial websites such as Facebook™, Twitter™, LinkedIn™, etc. Internet forum data (e.g., also called message board data) may comprise online discussion information (of a website) wherein the website presents saved written communications of forum users (these written communications may be organized or curated by topic); in some examples, forum data may comprise a question and one or more public answers (e.g., question and answer (Q&A) data). Of course, Q&A data may form parts of other data types as well. Image data may comprise information from commercial websites such as YouTube™, Instagram™, other photo-sharing sites, and the like. Mobile device data may comprise Short Message System (SMS) or other short message data, mobile device location data, etc. Communication data may comprise chat data, instant message data, phone recording data, collaborative software data, conversation history saved as part of the slot-filling system disclosed herein, etc. And media data may comprise Motion Pictures Expert Group (MPEG) Audio Layer Ills (MP3s), digital photos, audio files, video files (e.g., including video clips (e.g., a series of one or more frames of a video file)), etc.; and some media data may overlap with image data. These are merely examples of unstructured data; other examples also exist. Further, these and other suitable types of unstructured data may be received by the dialogue computer 10—receipt may occur concurrently or otherwise.

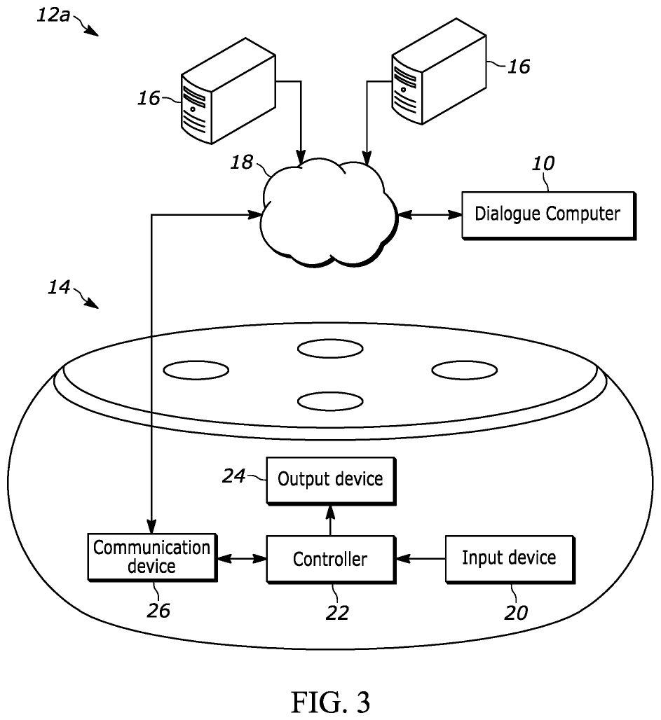

As shown in FIGS. 1 and 2, the dialogue computer 10 may be any suitable computing device that is programmed or otherwise configured to receive a query from the input device 20 (e.g., from HMI 14) and provide an answer using a neural network or machine learning that employs a language model. The dialogue system 12 may comprise any suitable computing components. According to an example, dialogue computer 10 comprises one or more processors 30 (only one is shown in the diagram for purposes of illustration), memory 32 that may store data received from the user and/or the storage media devices 16, and non-volatile memory 34 that may store data and/or a plurality of instructions executable by processor(s) 30.

Processor(s) 30 may be programmed to process and/or execute digital instructions to carry out at least some of the tasks described herein. Non-limiting examples of processor(s) 30 include one or more of a microprocessor, a microcontroller or controller, an application specific integrated circuit (ASIC), a field-programmable gate array (FPGA), one or more electrical circuits comprising discrete digital and/or analog electronic components arranged to perform predetermined tasks or instructions, etc.—just to name a few. In at least one example, processor(s) 30 read from memory 32 and/or non-volatile memory 34 and execute multiple sets of instructions which may be embodied as a computer program product stored on a non-transitory computer-readable storage medium (e.g., such as in non-volatile memory 34). Some non-limiting examples of instructions are described in the process(es) below and illustrated in the drawings. These and other instructions may be executed in any suitable sequence unless otherwise stated. The instructions and the example processes described below are merely embodiments and are not intended to be limiting.

Memory 32 may include any non-transitory computer usable or readable medium, which may include one or more storage devices or storage articles. Exemplary non-transitory computer usable storage devices include conventional hard disk, solid-state memory, random access memory (RAM), read-only memory (ROM), erasable programmable read-only memory (EPROM), electrically erasable programmable read-only memory (EEPROM), as well as any other volatile or non-volatile media. Non-volatile media include, for example, optical or magnetic disks and other persistent memory, and volatile media, for example, also may include dynamic random-access memory (DRAM). These storage devices are non-limiting examples; e.g., other forms of computer-readable media exist and include magnetic media, compact disc ROM (CD-ROMs), digital video disc (DVDs), other optical media, any suitable memory chip or cartridge, or any other medium from which a computer can read. As discussed above, memory 32 may store one or more sets of instructions which may be embodied as software, firmware, or other suitable programming instructions executable by the processor(s) 30— including but not limited to the instruction examples set forth herein. In operation, processor(s) 30 may read data from and/or write data to memory 32. Instructions executable by the processor(s) 30 may include instructions to receive an input (e.g., utterance or typed language), utilize a language model to unpack the input and determine what is the intent of the user or input, determine whether the intent requires slots to be filled, determine whether the input provides suitable data to fill those slots, query the user to provide slot-filling answers to fill any unfilled slots, determine an intent of the input received in response to the query, determine if the intent of the input received in response to the query has a slot-filling intent, determining whether additional input provides slot-filling answers based on stored conversation history, and providing responsive outputs to the user, as will be described more fully herein.

Non-volatile memory 34 may comprise ROM, EPROM, EEPROM, CD-ROM, DVD, and other suitable non-volatile memory devices. Further, as memory 32 may comprise both volatile and non-volatile memory devices, in at least one example additional non-volatile memory 34 may be optional.

While FIG. 1 illustrates an example of the HMI 14 that does not comprise the dialogue computer 10, in other embodiments the dialogue computer 10 may be part of the HMI 14 as well. In these examples, having dialogue computer local to and even sometimes within a common housing of the HMI 14 enables portable implementations of the dialogue system 12.

Communication network 18 facilitates electronic communication between dialogue computer 10, the storage media device(s) 16, and HMI 14. Communication network 18 may comprise a land network, a wireless network, or a combination thereof. For example, the land network may enable connectivity to public switched telephone network (PSTN) such as that used to provide hardwired telephony, packet-switched data communications, internet infrastructure, and the like. And for example, the wireless network may comprise cellular and/or satellite communication architecture covering potentially a wide geographic region. Thus, at least one example of a wireless communication network may comprise eNodeBs, serving gateways, base station transceivers, and the like.

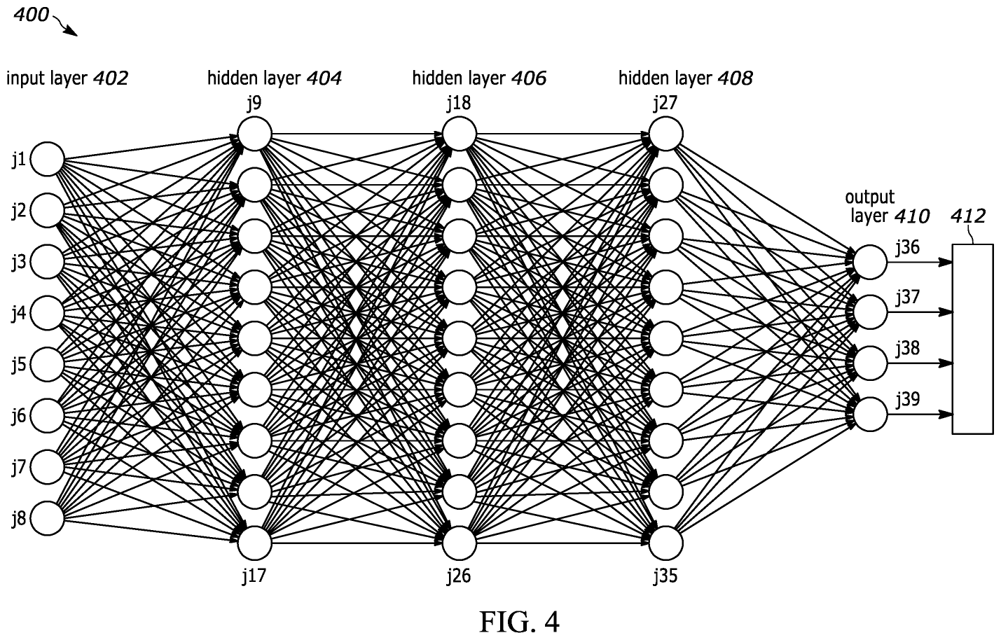

FIG. 3 illustrates one embodiment of a dialogue system 12a (e.g., Q&A system). According to the illustrated embodiment, the dialogue system 12a includes an HMI 14 that is an electronic personal assistant, such as one of the ones described above that includes the input device 20, the controller 22, the output device 24, and the communication device 26. The HMI 14 may be configured to receive any request from the user via input device 20, determine an intent of the request, determine if the request requires any slots to be filled, communicate with storage 16 and/or memory 32/34 to store conversation history, and determine if the intent of the request or any subsequent input from the user includes slot-filling information based on the stored conversation history.

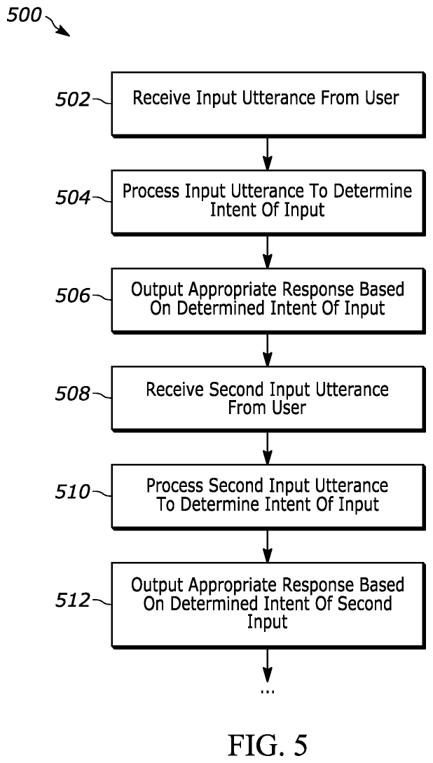

FIG. 4 illustrates an embodiment of a language model 400. As discussed above, the language model 400 may be a neural network (e.g., and in some cases, while not required, a deep neural network) or other such machine-learning model. The language model may be configured as a data-oriented language model that uses a data-oriented approach to determine an answer to a question. Language model may comprise an input layer 402 (comprising a plurality of input nodes, e.g., j1 to j8) and an output layer 410 (comprising a plurality of output nodes, e.g., j36 to j39). The illustrated quantities of input and output nodes are merely examples; other quantities may be used instead. In some examples, language model 400 may comprise one or more hidden layers (e.g., such as an illustrated hidden layer 404 (comprising a plurality of hidden nodes j9 to j17), an illustrated hidden layer 406 (comprising a plurality of hidden nodes j18 to j26), and an illustrated hidden layer 408 (comprising a plurality of hidden nodes j27 to j35). The nodes of the layers 402 404, 406, 408, and 410 may be coupled to nodes of subsequent or previous layers. And each of the nodes j36 to j39 of the output layer 410 may execute an activation function—e.g., a function that contributes to whether the respective nodes should be activated to provide an output of the language model 400 (e.g., based on its relevance to the answer to the query). The quantities of nodes shown in the input, hidden, and output layers 402-410 of FIG. 4 is merely an example; any suitable quantities may be used.

According to the example shown in FIG. 4, output node values of at least some of the output nodes j36-j39 are provided to an output selection 412. The output selection 412 is configured to determine which of the answers provided by the output nodes j36-j39 should be selected as an answer the user's query or input. According to at least one non-limiting example, processor(s) 30 of dialogue computer 10 select the output node which has a highest probability value of a probability distribution. Thus, output selection 412 may be an electrical circuit which determines a highest probability value, software or firmware which determines the highest probability value, or a combination thereof.

Once the answer is selected, the answer is provided to the HMI 14. As described above, via at least one output device 24, the user is presented with the answer or output from the output selection 48. Thus, continuing with the example above, a user may approach HMI 14 (e.g., a digital personal assistant), utter a follow-up query via the input device 20, the controller 22 may provide the query to the communication device 26, the communication device 26 may transmit it to the dialogue computer 10, the dialogue computer 10 may execute the language model (as described above). Upon determination of an answer to the query, the dialogue computer 10 may provide the answer to the communication device 26, the communication device 26 may provide the answer to the controller 22, and the controller 22 may provide the answer to the output device 24, wherein the output device 24 may provide the answer (e.g., audibly or otherwise) to the user.

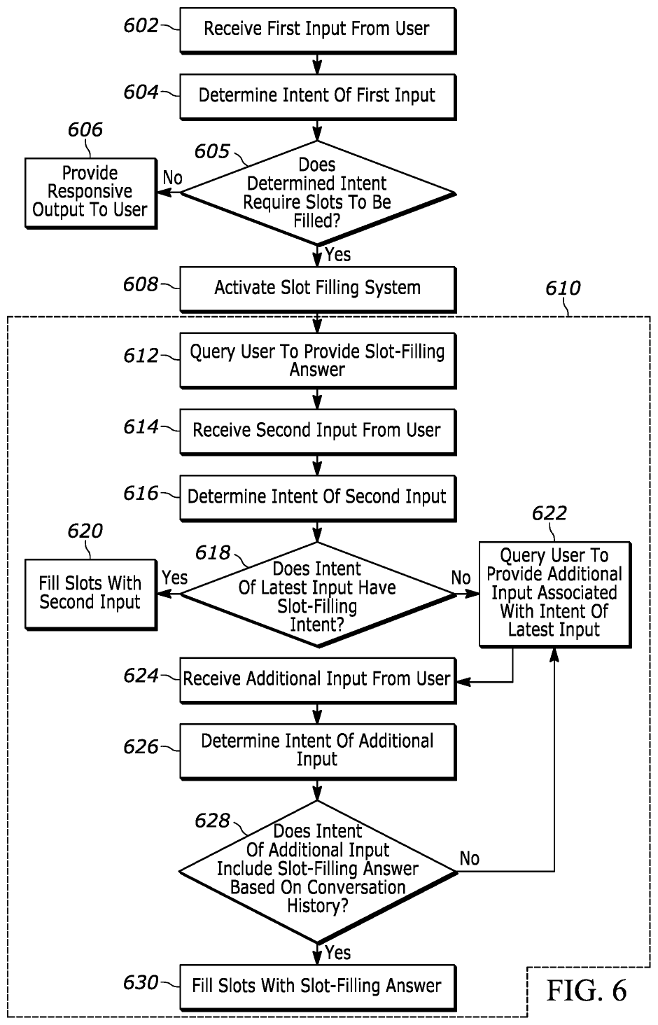

FIG. 5 illustrates a basic flowchart 500 or method of using a dialogue system 12, according to an embodiment. The steps of the flowchart 500 can rely on the structure (e.g., processors, memory, storage, input device, output device, HMI, etc.) described above with reference to FIGS. 1-3. At 502, an input utterance is received from the user, e.g., by the input device 20. As one example, the input utterance can be a simple request such as “Can I have a pepperoni pizza?” The processor(s) 30 processes the input utterance to determine the intent of the input at 504 by, for example, utilizing a machine-learning model such as those described herein and illustrated as an example in FIG. 4. Given this example, the processor(s) 30 may determine the intent of the user is to order a pizza. The dialogue system 12 then outputs an appropriate response based on the determined intent of the input at 506, e.g., by the output device 24. An example of an appropriate response may be “What size of pizza would you like?”

In response to receiving this output from the dialogue system 12, the user may provide a second input which is received by the dialogue system 12 at 508, e.g., by the input device 20. The second input utterance may be, for example, “I'll have a small pizza.” The second input is processed at 510 to determine the intent of the input. The processor(s) 30 may determine that the intent of the second input is that the user wants a small pizza. At 512, the dialogue 512 outputs an appropriate response based on the determined intent of the second input. Such an appropriate response might be, for example, a confirmation of the order such as “did you say you would like your pizza to be small?” This back and forth between the user and the dialogue system 12 may continue. For example, the user may want to add to his/her order (e.g., “I'd also like to order a drink”) or change topics altogether (e.g., “what is the weather out now?”), to which the dialogue system 12 can provide appropriate responses.

Slot filling is a common strategy used in a dialogue system to automatically collect necessary information for fulfilling user requests. Slot filling identifies from the running dialog, difference slots which correspond to different parameters of the user's query. For example, when a user queries for nearby restaurants (e.g., “what are the nearby restaurants”), key slots that should be filled to assure a proper response might include locational information, time of day, hours of operation for nearby restaurants, food preferences, and the like. Some of these slots can be filled without requiring input from the user, such as locational information (e.g., from a GPS system), time of day (e.g., from an internal clock), hours of operation (e.g., from a database of restaurant hours of operation). But, some slots might need input from the user, such as food preferences. When a slot-filling procedure is activated, the dialogue system can be configured to find out, in a subsequent utterance, an input from the user to help fill one or more of those slots. For example, the output provided to the user may be “what type of food are you interested in?” which allows the user to provide an utterance that would help fill the food-preference slot, thus providing a more accurate answer than if such information was not provided.

In an example slot-filling scenario, the dialogue system can automatically trigger a slot-filling system in response to identifying an intent of the user's input, and determine a corresponding one or more required slots to be filled to provide the best answer back to the user. Each slot to be filled may be associated with a prompt question that, when answered by the user, provides information to fill the slot.

The slot-filling system may work fine if the user follows the linear, prescribed way to answer the prompt question. But unfortunately, humans tend not to do this—they instead communicate using natural language, branch off at tangents, and jump from one topic to another simultaneously and interactively. If a user deviates from the planned slot-filling script, traditional dialogue systems cannot handle it correctly, provide inadequate outputs to the user, or outputs that seem entirely misplaced or discontinuous with the user's conversation. Moreover, simultaneous handling of a slot-filling system and other conversations can present a challenge for the dialogue system.

These problems can be illustrated in the following example. A user may wish to order a pizza through a pizza-ordering chatbot, which can take orders from customers by text or voice command, then submit a request to the kitchen to prepare the pizza. The user may provide the dialogue system with an input such as “I want to order a pizza.” To assure the pizza is made to order, the order must include necessary parameters such as pizza toppings and size. If the initial user request does not have that information in it, the dialogue can be programmed to ask the user about it. Therefore, the chatbot may respond to the user—“what toppings would you like on your pizza?” In a first example, the user responds with “what toppings are available?” In a second example, the user responds with “I want a medium pepperoni pizza.” In a third example, the user responds with “I heard that pepperoni is very popular here, is that true?” Each of these three answers by the user might make sense in a human-to-human dialogue, but may be difficult for a chatbot to properly process. For example, in the second example, the chatbot may not know whether this input from the user is a request to have his/her toppings be pepperoni, or is a request to start a new pizza order. In the third example, the chatbot might improperly assume the user wants pepperoni on his/her pizza when, in reality, the user is intending to know whether pepperoni is popular before actually placing that topping as part of his/her order.

Therefore, according to various embodiments described herein, a dialogue system is provided that can more intuitively, more smoothly, and more accurately respond to the user in the event the user deviates from a linear question-and-answer flow designed to fill necessary slots. The dialogue system includes a slot-filling system that can store slot-filling context in a conversation history, respond to a user that deviates from the slot-filling setting, and determine if slot-filling answers are provided in subsequent inputs from the user based on the saved conversation history. This can help fill slots with information found in user requests that are multiple questions and answers removed from the original slot-filling request. If the user deviates from the linear progression and/or provides input that does not provide a slot-filling answer, the chatbot can store the slot-filling context, proceed with an appropriate answer to the user's non-slot-filling answer, and determine if a subsequent input from the user includes the sought-after slot-filling answer based on the slot-filling context saved in conversation history.

According to embodiments described herein, the chatbot or dialogue system may determine that a first input by the user has an intent that requires slots to be filled, thus activating a slot-filling system. Doing so causes slot-filling context (e.g., slots that are not filled by the first input, slots that are filled by the first input) to be stored in conversation history in memory. The slot-filling context can have a lifespan that defines the number of dialogue rounds for which context remains valid. Therefore, users do not need to answer the slot-filling prompt question immediately. The chatbot can remember the slot-filling procedure for several back-and-forth dialogue rounds between the human and the dialogue system. Users can switch to another topic, and come back to answer the slot-filling prompt question later as long as the slot-filling context is still valid—e.g., the slot-filling system is still active. The slot-filling system can remain active—and thus storing and recalling conversation history—so long as the slots remain unfilled, or until a certain number of Q&As or inputs are received from the user.

Determining intent of the user input is thus an important part of slot-filling, and activating the slot-filling system. Since the slot-filling answer may appear in a random dialogue round subsequent to when the dialogue system actually asked the user for a prompt to fill the slot, it is important to identify the slot-filling answer in subsequent inputs by the user. For example, considering the following back and forth between the user and the chatbot of the dialogue system:

User: I would like to order a pizza.
Chatbot: What type of toppings would you like?
User: Do you have pineapple?

### Chatbot: Yes, we do.

User: Do you have square pizza?

### Chatbot: Yes, we do.

User: Ok, I'll do pineapple.

In this exchange, the teachings of this disclosure allow the dialogue system to recognize that the final input by the user (“Ok, I'll do pineapple”) has an intent to order toppings related to his previous intent of ordering a pizza. When the user makes his/her first input of “I would like to order a pizza,” the dialogue system recognizes that several slots are present that need to be filled, such as the size of the pizza, the type of pizza, the toppings, etc. The conversation history is stored in memory, and the dialogue system is able to fill a slot regarding the toppings even though the input (e.g., “pineapple”) is not received until three subsequent inputs after the original input.

A slot-filling system may be triggered and activated, thus storing the conversation history in memory and allowing the dialogue system to recall, from conversation history, information that will help the dialogue system recognize any slot-filling intent or information from subsequent inputs by the user. The slot-filling system may be ceased or discontinued once all of the slots are filled, or a certain number of inputs have been received by the user. In one embodiment, when the slot-filling system is discontinued, the slot-filling system will not look back to the conversation history to determine if slot-filling intents are present in the input. In another embodiment, when the slot-filling system is discontinued, the slot-filling system will place less weight on the conversation history when determining the intent of the subsequent inputs received by the user.

For purposes of this disclosure and for clarity, the input that causes a slot-filling system to be activated will be referred to as a “first” input or “original” input, even though there may be other inputs received before the “first” input or “original” input. A determination of whether an intent from the user has slot-filling intent can be made in response to the slot-filling system being activated. Thus, it should be a follow-up intent after the first intent that has the slot-filling context as its input context. All slots in the original intent are also defined in the slot-filling answer intent. This allows the user to provide multiple slot values in one answer (e.g., “I'd like a small pepperoni pizza” fillings a pizza-topping slot and a pizza-size slot), without triggering other redundant slot-filling systems if some slots are missing.

If an input received by the user after the first input includes an expected slot answer (e.g., “pepperoni”) in the input, the slot-filling system can determine that that input has a slot-filling-answer intent. When the slot-filling-answer intent is detected, the slot-filling system will move to the next stage; if not, the slot-filling system will return the prompt question again (e.g., “What type of topping would you like?”).

It should be understood that the dialogue system may implement any suitable natural language understanding (NLU) algorithm or model for determining the intent of each input, and any slot-filling intent of the inputs. The NLU can use different algorithms, deep learning, statistic-based or rule-based models, etc. A variety of sample slot-filling answers can be collected to train the models of the dialogue system to help the NLU to identify the slot-filling answer and extract slot values from the inputs. Various NLU platforms may be utilized, such as Dialogflow. Using Dialogflow with input context can be used to control conversation flow. While a context is valid in the conversation history, the chatbot is more likely to select intents that are configured with matching input context. On the other hand, the intent configured with an input context which is not saved in the conversation history, will not be selected by the chatbot.

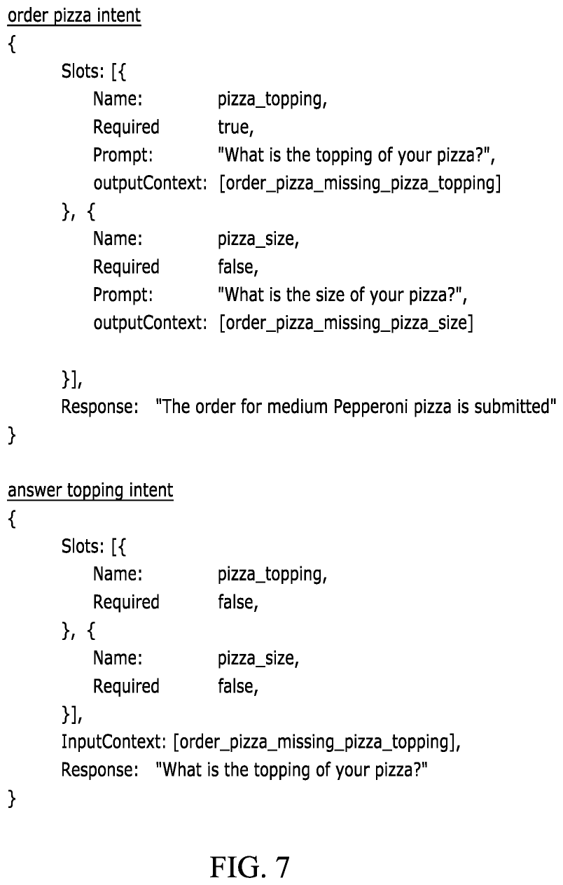

FIG. 6 provides a flowchart 600 illustrating operation of a dialogue system 12 according to an embodiment. The following exemplary Q&A session will be referred to during the explanation of the flowchart 600:

First User Input: I want to order a pizza.
First Chatbot Response: Sure. What toppings would you like on your pizza?
Second User Input: Do you have margarita pizza?
Second Chatbot Response: We have cheese, pepperoni, meat lovers, and vegetarian pizza.
Third User Input: Ok, I want a pepperoni pizza.

As described above, without the teachings of this disclosure, the system might otherwise have difficult with the third user input. Is this an original intent to start a new order? Or is this a response that provides a slot-filling answer? By using the dialogue system flow as exemplified in FIG. 6, the dialogue system is better suited to handle such human-machine interactions with less error and more accuracy in resembling true human dialogue.

At 602, the dialogue system received a first input from the user. In this example, the first input may be “I want to order a pizza.” This input may be received via the input device 20 described above. For example, this input may be a spoken or written utterance at a HMI 14.

At 604, the dialogue system may implement a machine-learning model, such as the language model 400 described above with reference to FIG. 4, to determine the intent of the first input. In this example, the intent of the first input may be determined to be that the user desires to place an order for a pizza (order_pizza intent).

At 605, the machine-learning model (e.g., language model 400, NLU, etc.) of the dialogue system determines whether the determined intent of the first input requires slots to be filled. If the answer is no, then at 606 the dialogue system provides a responsive output to the user via the output device of the HMI 14. Such a responsive output may be “Ok, will this complete your order?” for example. If, however, there are slots to be filled, the process proceeds to 608. For example, in the above Q&A session, the dialogue system may determine that when a user has a first intent to order a pizza, by default several slots are to be filled, such as pizza toppings, pizza size, pizza type (e.g., round or square), and the like. If one or more of these slots are not filled by data in the first input itself, such as the case in the Q&A session example above, then at 608 the dialogue system activates a slot-filling system 610.

When the slot-filling system is activated, slot-filling context may be stored in a conversation history of the memory of the dialogue system for recall by the system as long as the slot-filling system is active. The slot-filling context may include a current status of the slot-filling system, such as missing parameters of the first intent (e.g., slots that are not filled), and already-filled parameters of the first intent (e.g., slots that are filled). In this example Q&A session, the pizza toppings, pizza size, and pizza type may all be slot-filling context, representing slots that need to be filled.

The dialogue system proceeds to 612 to query the user to provide a slot-filling answer. For example, understanding that the pizza_toppings slot is not filled, the chatbot response with a prompt to ask the user to fill that slot. In the example Q&A session above, this is represented by the first chatbot response: “Sure. What toppings would you like on your pizza?” Again, this output may be provided via the output device 24 of the HMI 14.

At 614, the input device 20 of the HMI 14 receives a second input from the user and again transmits that second input to the associated processing device. The processing device determines, at 616, the intent of the second input by again utilizing the language model 400, for example. The language model 400 will determine, based on its neural network or machine-learning structure, the most likely or probable intent of the second input. And, at 618, the dialogue system determines whether the intent of the second (latest) input has slot-filling intent. If the intent of the latest input does have slot-filling intent, then the system fills the associated slot with the information from the second input at 620. For example, if the user simply responds “I'll have pepperoni” to the first chatbot response, then the pizza_topping slot can be filled with information indicating the user wants pepperoni as the topping. If, however, the intent of the latest input does not have slot-filling intent at 618, then the system proceeds to 622. Given the example Q&A session above, the second input may be “Do you have margarita pizza?” This latest input does not have any slot-filling intent, i.e., the machine-learning model does not recognize this second input to be an appropriate response to fill the pizza_topping slot. In this case, the intent of the latest input may be a desire to ask what toppings are available. Therefore, at 622, the dialogue system responds with an output associated with the intent of the latest input. In the Q&A session above, this is represented by the second chatbot response: “We have cheese, pepperoni, meat lovers, and vegetarian pizza,” which is associate with the determined intent of the second input.

At 624, the dialogue system receives and additional input from the user, and at 626 determines the intent of the additional input. These steps may be performed similar to steps 614 and 616 explained above. In the Q&A session example above, the additional input may be the third input from the user: “Ok, I want a pepperoni pizza.” At 628, the dialogue system determines whether the intent of the additional input (e.g., third input in this example) includes slot-filling answers associated with the slots that are left unfilled from the first input. This can be done based on the slot-filling context saved in the conversation history in memory. For example, the system can recall from memory that a slot associate with pizza toppings remains unfilled. Because the third input from the user includes information associated with the unfilled slot, (e.g., “pepperoni”), the dialogue system can determine the intent of the third input includes a slot-filling answer. Thus, at 630, the dialogue system fills the slot with the slot-filling answer. If, alternatively, the third input did not include any information that shows a slot-filling intent (e.g., the third user input were instead “and do you have square pizza?”), the process would return to 622. And, as mentioned above, the slot-filling system 610 can continue until the slots are filled, or until a certain number of inputs are received by the user which may indicate that the user has forgotten or does not intend to return back to the original intent of the first input. In one embodiment, the certain number of inputs that cause the slot-filling system to deactivate is five inputs, although this is merely an example and the number of inputs can be more or less than five.

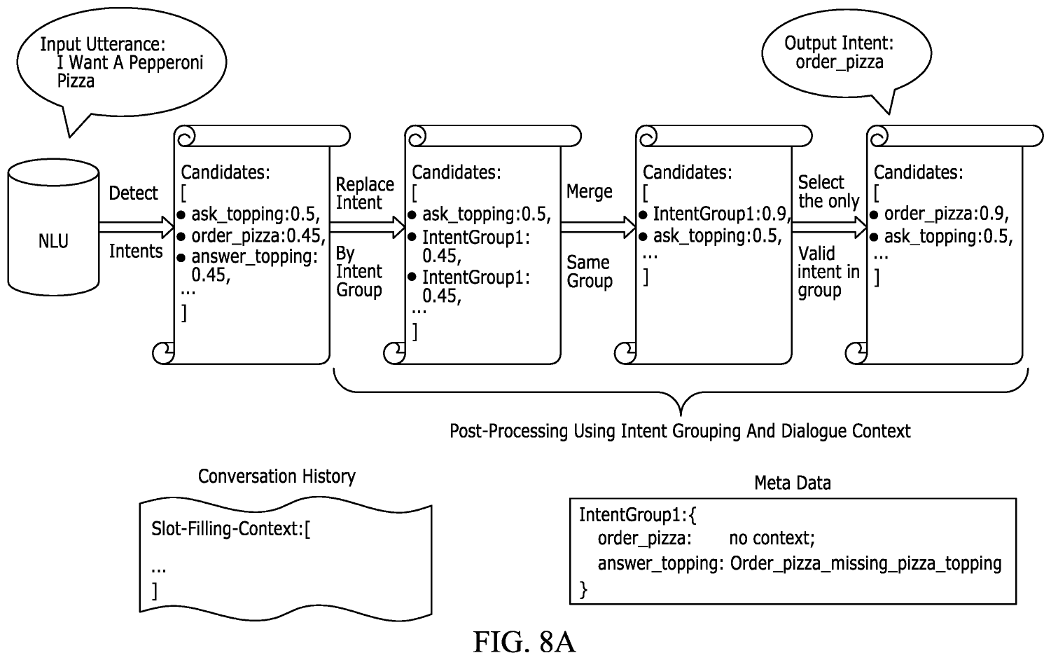

For example, FIG. 7 illustrates an example of code used to define a slot-filling answer intent for the original intent without a required slot being provided, according to an embodiment. Here, with a first input or original input having a determined intent to order pizza (“order_pizza intent”), pizza_topping and pizza_size are two slots that need to be filled to complete the order. A single input received many iterations or inputs later than directly subsequent to a slot-filling prompt may include information that fills one or more of these slots. The slot-filling answer is also defined, e.g., answer_topping, for the original intent order_pizza without requiring slot pizza_topping to be prompted.

According to embodiments disclosed herein, intent grouping is also utilized. Defining the slot-filling answers as a separate intent can help the dialogue system to detect the slot-filling answer in flexible dialogue rounds with a variety of formats. However, sometimes the slot-filling answers may be similar to the original intent. For example, looking at the Q&A session explained above with reference to the flow chart of FIG. 6, the third input from the user (“Ok, I want a pepperoni pizza”) is very similar to the first intent (“I want to order a pizza”). For chatbots prior to this disclosure, the NLU does not use the runtime saved conversation history at all, and it detects intent based on a pre-trained model only. In other words, it is not context aware. When the NLU would receive this third input, it would get confused and not know whether this was a slot-filling answer or a new original intent. Later, when the dialogue system post-processes the NLU result, it can use the conversation history to find out which intent candidate is most suitable in the current context. But there is no guarantee that the NLU can return the proper candidates. Based on different NLU algorithms and training datasets, the NLU may assign low confidence to ambiguous intents to make both of them with lower priority than other intents. To solve the problem caused by the ambiguity between the original intent and the slot-filling-answer intent, intent grouping is introduced.

An intent group can be defined to include a set of ambiguous intents. Utilizing the dialogue system disclosed herein, based on the current context, only one intent in the group is valid. After the NLU generates a set of candidate intents, the dialogue system can post-process those candidates and select one candidate as the detected intent.

In short, first the dialogue system selects each candidate intent from the NLU representing a possible intent of the input. If a candidate intent belongs to an intent group, it is replaced by the intent group. If multiple intents are converted to the same intent group, the multiple intents can be merged into one candidate, and their confidence value can be summed together to get a higher confidence for the merged candidate. The candidate with the highest confidence in the NLU result is selected. If the selected candidate is an intent group, the dialogue system picks the intent from the group which is valid in the current context.

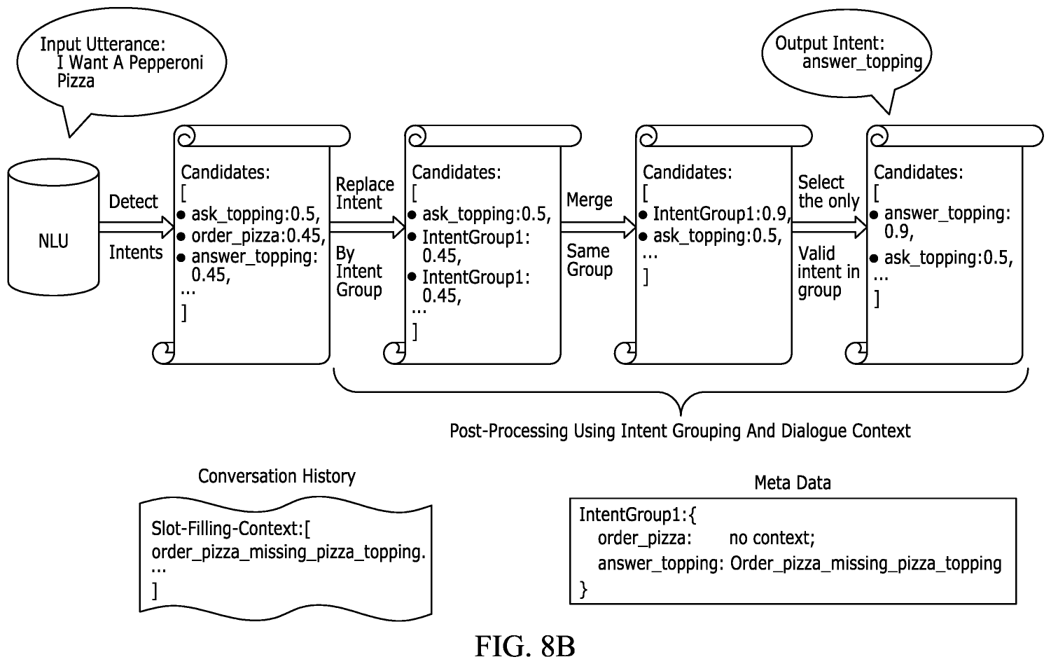

An example of this intent grouping is shown in FIGS. 8A-8B. FIG. 8A represents a dialogue system with no slot-filling context saved in the conversation history, while FIG. 8B represents a dialogue system with slot-filling context saved in the conversation history, thereby producing a different detected intent of the input.

In both FIGS. 8A and 8B, the same input utterance is received and processed by the NLU: “I want a pepperoni pizza.” The respective dialogue system then begins at 802 by detecting the intent of the input utterance by producing a list of candidate intents. Here, the candidate intents are ask_topping (e.g., representing an intent by the user to ask what toppings are available), order_pizza (e.g., representing an intent by the user to place an order for a pizza), and answer_topping (e.g., representing an intent by the user to answer which topping he/she would like). Other candidates can be present, and the list shown in FIGS. 8A-8B is merely an example. Each candidate intent is provided with a confidence score, in this case ranging from 0 to 1, in which 0 is no confidence and 1 is ultimate confidence. Some other candidate intents having a 0 confidence score may include, for example, answer_size (e.g., representing an intent by the user to provide a size of pizza). This candidate is not a realistic candidate because the dialogue system recognizes that no words representing a “size” of the pizza were uttered, for example the word “size,” “large,” “medium,” etc.

At 804, the dialogue system recognizes that certain candidate intents—in this case, order_pizza and answer_topping—are part of a similar intent group, namely IntentGroup1. Several groups may be defined in the system, and each group may have overlapping candidate intents in that respective group. For example, IntentGroup1 may include order_pizza and answer_topping candidate intents, while IntentGroup2 includes order_pizza and answer_size candidate intents. At 806, the candidate intents belonging to the same group can be merged and their confidence scores summed. In other words, the order_pizza candidate intent and the answer_topping candidate intent are merged into a single candidate group intent (IntentGroup1) and the confidence score of 0.9 is provided, representing a combined score of 0.45 for each candidate intent in the group.

Then, at 808, since the combined confidence score of the group intent (IntentGroup1) is higher than the remaining candidate intents outside of the group (e.g., ask_topping), only an intent from the group of intents is selected as the determined intent. Thus, looking back to 802, the candidate intent with the highest confidence score (e.g., ask_topping) is not the eventual determined intent. Of course, in other embodiments, a candidate intent may ultimately have a determined confidence score that is higher than even the score of an intent group, and in that case, that candidate intent may be determined to be the actual intent outputted.

However, step 808 illustrates a difference between the system of FIG. 8A and the system of FIG. 8B. In both step 808 of FIG. 8A and step 808′ of FIG. 8B, the candidate intent with the highest confidence score within the intent group (IntentGroup1) is output as the determined intent. However, two candidate intents have the same confidence score, e.g., order_pizza and answer_topping. In FIG. 8A, because there is no conversation history (e.g., no slot-filling context saved in memory), the dialogue system selects order_pizza as the valid intent at 808, and the output intent 810 is order_pizza. This is because there is no slot-filling context. However, in FIG. 8B, the dialogue system is provided with slot-filling context stored in the conversation history. In this case, the slot-filling context includes order_pizza_missing_pizza_topping, representing an unfilled slot for pizza topping related to a previous attempt to order a pizza. In other words, given the Q&A session described above, the first intent or “I want to order a pizza” may cause the slot-filling system to save context into the conversation history that the slot for pizza toppings remains unfilled. Then, if the user does not directly answer the query to fill a topping slot (as is the case in the second input in this Q&A session), a subsequent input by the user (e.g., the third user input) which is the input utterance in FIG. 8A-8B is processed with the slot-filling context. Therefore, as shown in FIG. 8B, since the order_pizza_missing_pizza_topping slot-filling context is saved, the candidate intent (answer_topping) that is relevant to this slot-filling context is selected as the output intent. Thus, at 810′, the output intent is answer_topping instead of order_pizza because answer_topping corresponds with the slot-filling context of order_pizza_missing_pizza_topping (e.g., the unfilled slot).

In other embodiments, the slot-filling context can alter the confidence rating of one or more of the candidate intents or their intent group. For example, when selecting the candidate intent within the intent group at 808, the dialogue system may increase the confidence score of a candidate intent if that candidate intent is related to the slot-filling context. Referring to FIG. 8, assume the answer_topping score is 0.40, thus lower than the order_pizza confidence score of 0.45. When the dialogue system selects the valid intent in the group, it may increase or “boost” the confidence score of answer_topping because it is related to the slot-filling context of the unfilled slot of the pizza topping (e.g., order_pizza_missing_pizza_topping). The answer_topping may be the output intent even though it has a lower original confidence score at 802. The amount of increase of the confidence score may be altered in various embodiments. Alternatively, the confidence score may be determined at 802 directly based on the slot-filling context. In other words, the answer_topping candidate intent may be increased to 0.50 since it is related to the slot-filling context.

In an embodiment, when the slot-filling system is activated, the candidate intent within the merged intent group is selected at 808′ as being the candidate intent that relates to the conversation history. This can be regardless of the confidence score of that candidate intent. And, in an embodiment, when the slot-filling system is not activated, the candidate intent within the merged intent group is selected at 808 as being the candidate intent having the highest confidence score within the intent group.

It should be understood that the terms “first,” “second,” “third,” and the like are not intended to be directly sequential with nothing in between, unless otherwise stated. A “first” input is not necessarily the very first input received by the user, but is merely an input that is different than a “second” input. Likewise, a “second” input does not necessarily have to be an input that is received directly after the first input (there may be other inputs between the first and second inputs), but is simply a term to distinguish the second input form the first input.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A computer-implemented method of operating a dialogue system, the computer-implemented method comprising:
at a chatbot, receiving a first input from a user;
identifying a first intent of the first input;
based on the first intent, activating a slot-filling system and saving slot-filling context in a stored conversation history, wherein the slot-filling context corresponds to the first input;
with the slot-filling system activated:
at the chatbot, querying the user to provide a slot-filling answer;
at the chatbot, receiving a second input from the user responsive to the querying;
identifying a second intent of the second input, wherein the second intent is determined to have non-slot-filling intent;
in response to the second intent of the second input having the non-slot-filling intent, querying the user to provide additional input associated with the second intent;
at the chatbot, receiving a third input from the user; and
determining that a third intent of the third input includes the slot-filling answer based on the slot-filling context saved in the conversation history.

2. The computer-implemented method of claim 1, wherein the slot-filling context includes a current status of the slot-filling system, wherein the current status includes a missing parameter of the first intent, and already-filled parameters of the first intent.

3. The computer-implemented method of claim 1, wherein the slot-filling context includes information regarding slots corresponding to the first intent that are not yet filled.

4. The computer-implemented method of claim 1, further comprising deactivating the slot-filling system after all slots in the slot-filling system are filled, or after a number of non-slot-filling inputs are received by the user.

5. The computer-implemented method of claim 1, further comprising:
deactivating the slot-filling system;
at the chatbot, receiving a fourth input from the user; and
with the slot-filling system being inactive, determining a fourth intent of the fourth input without the slot-filling context.

6. The computer-implemented method of claim 1, further comprising:
defining all slots to be filled based on the first intent;
not filling any of the slots with information associated with the second input based on the second intent determined to have non-slot-filling intent; and
filling at least one of the slots with information associated with the third input based on the third intent determined to have slot-filling intent.

7. The computer-implemented method of claim 1, wherein the steps of identifying the first intent of the first input and identifying the second intent of the second input are performed utilizing one or more processors programmed to perform natural language understanding (NLU).

8. A system for operating a chatbot in a dialogue setting, the system comprising:
a human-machine interface (HMI) configured to receive input from a user and provide output to the user;
one or more storage devices; and
one or more processors in communication with the HMI and the one or more storage devices, the one or more processors programmed to:
at the chatbot, receive a first input from the user;
determine a first intent of the first input;
store, in the one or more storage devices, slot-filling context associated with the determined first intent;
at the chatbot, query the user to provide a slot-filling answer to fill a slot associated with the determined first intent;
at the chatbot, receive a second input from the user responsive to the query; and
determine a second intent of the second input based on the slot-filling context saved in storage.

9. The system of claim 8, wherein the one or more processors are further programmed to determine the second intent of the second input includes the slot-filling answer based on the slot-filling context saved in storage.

10. The system of claim 8, wherein the one or more processors are further programmed to:
activate a slot-filling system based on the determined first intent, and
determine the second intent of the second input based on the slot-filling context saved in storage only when the slot-filling system is activate.

11. The system of claim 10, wherein the one or more processors are further programmed to:
when the slot-filling system is inactive, determine the second intent of the second input without the slot-filling context.

12. The system of claim 8, wherein the slot-filling context includes a current status of the slot-filling system.

13. The system of claim 8, wherein the slot-filling context includes information regarding one or more slots corresponding to the first intent that are not yet filled.

14. The system of claim 13, wherein the one or more processors are further programmed to, after all of the one or more slots are filled:
at the chatbot, receive a third input from the user; and
determine a third intent of the third input without the slot-filling context.

15. The system of claim 13, wherein the one or more processors are further programmed to utilize natural language understanding (NLU) to determine the first intent and the second intent.

16. A computer-implemented method of operating a dialogue system, the computer-implemented method comprising:
at a chatbot, receiving an input from a user;
identifying a plurality of candidate intents corresponding to the input;
generating a confidence score for each candidate intent, wherein the confidence score indicates a confidence that the corresponding candidate intent is a valid intent of the input;
determining one or more of the candidate intents are part of a common intent group;
merging the one or more candidate intents into a merged intent group having a confidence score represented by the aggregate of the confidence scores of the candidate intents within the merged intent group;
selecting a largest of the confidence scores of the merged intent group or the plurality of candidate intents; and
based on the largest of the confidence scores being the merged intent group, determining an intent of the input as being one of the candidate intents within the merged intent group.

17. The computer-implemented method of claim 16, wherein:
when a slot-filling system is activated to save slot-filling context in storage from a previous input received prior to receiving the input, the one of the candidate intents within the merged intent group is determined as the intent of the input based upon the one of the candidate intents being stored in the slot-filling context.

18. The computer-implemented method of claim 17, wherein:
when the slot-filling system is not activated, the one of the candidate intents within the merged intent group is determined as the intent of the input based upon the one of the candidate intents having the largest confidence score within the merged intent group.

19. The computer-implemented method of claim 16, wherein the step of identifying the plurality of candidate intents corresponding to the input is performed using one or more processors programmed to perform natural language understanding (NLU).

20. The computer-implemented method of claim 16, further comprising:
at the chatbot, querying the user based upon the determined intent of the input.
